(19) United States
(12) Patent Application Publication
(10) Pub. No.: US 2014/0057037 A1
(43) Pub. Date: Feb. 27, 2014

(54) Sweetener Composition

(71) Applicant: McNeil Nutritionals, LLC, Fort Washington, PA (US)

(72) Inventors: Steven J. Catani, Athens, GA (US); William J. Chapello, Atlantic Highlands, NJ (US); Joseph R. Panarisi, Perrineville, NJ (US); Juan L. Navia, Doylestown, PA (US)

(73) Assignee: McNeil Nutritionals, LLC, Fort Washington, PA (US)

(21) Appl. No.: 13/957,881

(22) Filed: Aug. 2, 2013

Related U.S. Application Data
(60) Provisional application No. 61/693,449, filed on Aug. 27, 2012.

(51) Int. Cl. A23L 1/22; A23L 1/236

(52) U.S. Cl. CPC A23L 1/22091; A23L 1/236
USPC 426/548; 426/650

(57) ABSTRACT

A sweetening composition comprising a sweetener and one or more flavor compounds, wherein the flavor compound is at a level below that which 50% of users can identify the flavor compound when the sweetener composition is used in a user selected beverage or food.

This application claims priority of the benefits of the filing of U.S. Provisional Application Ser. No. 61/693,449, filed Aug. 27, 2012, the contents of each of which are hereby incorporated by reference in their entirety.

### BACKGROUND OF THE INVENTION

1. Field of the Invention

The present invention relates to a sweetener composition. More particularly, the present invention relates to a sweetener composition that has enhanced flavor attributes.

People often customize the taste of food and beverages by adding sweeteners thereto. For example, tabletop sweeteners are added to beverages, such as, coffee and tea. Sweeteners are also added on cereals, fruit, and as toppings on baked goods. The added sweetness imparted by the tabletop sweetener to a food or beverage alters its flavor and usually increases its appeal.

Personal taste creates considerable variability in the amount of sweetness that one person prefers in a given food or beverage versus another person. For example, the amount of sweetness incorporated into a foodstuff during commercial production may not be adequate to satisfy some consumers while other consumers may find that the same amount of sweetness to be excessive. Moreover, consumers often desire to reduce their caloric intake for health or lifestyle reasons. Tabletop sweeteners are the primary vehicle by which such taste customization is accomplished. Tabletop sweeteners are presently available in many different forms, including, granular, tablets, cohesive non-free flowing compositions (e.g., cubes), and the like. As such, there exists a need for tabletop sweetener products that consumers may use to increase the sweetness of a product at the time of consumption that are consistent with their personal preferences.

### SUMMARY OF THE INVENTION

A sweetening composition comprising a sweetener and one or more flavor compounds, wherein the flavor compound is at a level below that which 50% of users can identify the flavor compound when the sweetener composition is used in a user selected beverage or food.

A sweetening composition comprising a low calorie sweetener, a carrier, and one or more flavor compounds, wherein the sweetener composition has a caloric content of 2 kcal/g SES or less, and the flavor compound is at a level below that which 50% of users can identify the flavor compound when the sweetener composition is used in a user selected beverage or food.

### DETAILED DESCRIPTION OF THE INVENTION

As used herein, unless otherwise indicated, the term “sweetener” means any substance that produces a sweet taste when consumed and is deemed safe for human consumption.

As used herein, a gram of Sucrose Equivalent Sweetness (“SES”) is understood to mean the amount of high intensity sweetener needed to be added to an 8 ounce glass of water in order to provide the same sweetness as an independent 8 ounce glass of water containing four grams (about one teaspoon) of sucrose. For example, an intense sweetener that is 400 times the sweetness of sucrose on a weight basis 0.01 g (=4 g/400) to sweeten 8 ounces of water to an equivalent sweetness level as a teaspoon of sucrose. The SES can vary depending on the other flavors in, and physical properties of a food or beverage. This variability will be understood by one skilled in the art.

As used herein “comparable” is understood to mean a similar article or item.

As used herein “significant,” “substantial,” or “substantially” is understood to mean a measurable change that results in a beneficial or detrimental change in a material.

As used herein, unless otherwise indicated, the term “flavor” means any food-grade material that may be added to the present compositions to provide a desired flavor to a foodstuff Flavors useful in the present invention include, for example, cream, hazelnut, vanilla, chocolate, cinnamon, pecan, lemon, lime, raspberry, peach, mango, vanillin, butter, butterscotch, tea, orange, tangerine, caramel, strawberry, banana, grape, plum, cherry, blueberry, pineapple, elderberry, watermelon, bubblegum, cantaloupe, guava, kiwi, papaya, coconut, mint, spearmint, derivatives, and combinations thereof.

As used herein, unless otherwise indicated, the term “foodstuff” means any edible substance to which a sweetener may be added. Foodstuffs useful in the present invention include, for example, cereals, cakes, cookies, dairy products, beverages, e.g., coffee, tea, milk, and seltzer.

The present invention is a sweetening composition comprising a sweetener and one or more flavor compounds, wherein the flavor compound is at a level below that which 50% of users can identify the flavor compound when the sweetener composition is used in a user selected beverage or food.

The inventors have found that the taste of a beverage or food can be improved by adding a flavor compound at a level below that which 50% of users can identify the flavor compound when the sweetener composition is used in the beverage or food selected by the user. The imperceptible level at which the flavor or flavor compounds are present appear to give the beverage or food a more rounded, balanced, and/or pleasing taste. In some cases, the flavor or flavoring compounds are observed to enhance the perception of sweetness by the user.

An essential component of the inventive sweetener composition is a sweetener. The sweetener may be, for example, a caloric sweetener, a low calorie sweetener, or a mixture thereof.

Caloric sweeteners include sucrose (i.e., cane sugar), glucose, fructose, tagatose, lactose, trehalose, maltodextrin, soluble starch, inulin,honey, high fructose corn syrup, molasses, maple syrup, brown rice syrup, fruit juice sweeteners, barley malt, corn syrup, and the like, alone or in combination.

Low calorie sweeteners are, for example, aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, stevia, luo han guo, sugar alcohols, thaumatin, salts, derivatives, and combinations thereof.

Sugar alcohols are food-grade alcohols derived from a sugar molecule. Examples include isomalt, erythritol, hydrogenated isomaltulose, hydrogenated starch hydrolyzates, lactitol, maltitol, mannitol, sorbitol, xylitol, and combinations thereof.

Another essential component of the inventive sweetener composition is a flavor compound. One or more flavor compounds may be included in the inventive sweetener composition. Suitable flavor compounds include, but are not limited to vanilla, hazelnut, cinnamon, bergamot, mint, cocoa, mocha, caramel, karob, citrus (lemon, lime, orange, etc.), berry (raspberry, strawberry, lingonberry, assai, pomegranate, etc.), menthol, or combinations thereof.

As noted above, the flavor compound is included in the sweetening composition at a level below that which 50% of users can identify the flavor compound when the sweetener composition is used in the beverage or food selected by the user. Preferably, the flavor compound or compounds are at a level below that which 60% of users can identify the flavor compound when the sweetener composition is used in a user selected beverage or food. More preferably, at a level below which 70% of users can identify the flavor compound when the sweetener composition is used in a user selected beverage or food. In one embodiment, the flavor compound or compounds are at a level below that which 80% of users can identify the flavor compound when the sweetener composition is used in a user selected beverage or food.

Optionally, a carrier may be included. Suitable carriers include, for example, a monosaccharide, a disaccharide, inulin, fructooligosaccharide (FOS) and other fibers, maltodextrins, sugar alcohols such as erythritol, xylitol, sorbitol, lactisol, or disaccharides or oligosaccharides having a sugar alcohol at a chain terminus, a digestion resistant maltodextrin (e.g., FiberSol), a sugar polymer, such as polydextrose, and mixtures thereof.

Monosaccharides include, for example, glucose, fructose, galactose, xylose, ribose, and combinations thereof.

Disaccharides include, for example, sucrose, lactulose, lactose, maltose, trehalose, cellobiose, kojibiose, nigerose, isomaltose, β,β-trehalose, α,β-trehalose, sophorose, laminaribiose, gentiobiose, turanose, maltulose, palatinose, gentiobiulose, mannobiose, melibiose, melibiulose, rutinose, rutinulose, xylobiose, and combinations thereof.

Sugar alcohols are food grade alcohols derived from one or more sugar molecules. Sugar alcohols include, for example, erythritol, glycol, glycerol, threitol, arabitol, xylitol, ribitol, mannitol, sorbitol, dulcitol, iditol, isomalt, maltitol, lactitol, polyglycitol and combinations thereof.

The sweetening composition may be included in or added to a beverage such as coffee, tea, juice, flavored water, alcohol, soda, powdered soft drinks (e.g., KOOLAID) and mixtures thereof.

Food items that may include or to which the sweetening composition may be added are, for example, any food item that may include a sweetener.

In one embodiment, the sweetener composition has a caloric content of 2 kcal/g SES or less.

Moreover, the compositions of the present invention may be in any form commonly used to sweeten a foodstuff Composition forms useful in the present invention include, for example, powders (e.g., loose powders), granules, tablets, cubes, slurries, syrups, and liquids.

The composition of claim 16, wherein the composition is used as a sweetener in a beverage.

The sweetening composition may be formulated to be a zero calorie or low calorie product. In one embodiment, the natural sweetener composition may be formulated to have less than 2 kcal per gram of SES. In another embodiment, the sweetening composition has less than 1 kcal per gram of SES. In yet another embodiment, the sweetening composition has less than 0.5 kcal per gram of SES. In still yet another embodiment, the sweetening composition has less than 0.25 kcal per gram of SES.

Additionally, the sweetener composition has a density of from about 0.1 g/cm3 to about 1.0 g/cm3. Preferably, from about 0.1 g/cm3 to about 0.9 g/cm3. More preferably, from about 0.5 g/cm3 to about 0.8 g/cm3.

Additionally, a variety of ingredients may be included in the sweetening composition of the present invention. Ingredients, such as, for example, water, texture enhancers, coloring agents, vitamins, minerals, and combinations thereof.

In one embodiment, the sweetening composition comprises a low calorie sweetener, a carrier, and one or more flavor compounds, wherein the sweetener composition has a caloric content of 2 kcal/g SES or less, and the flavor compound is at a level below that which 50% of users can identify the flavor compound when the sweetener composition is used in a user selected beverage or food.

Various methods may be employed to manufacture the inventive sweetening composition. For example, the sweetening composition may be produced by blending and mixing each ingredient in a mixer. In another embodiment, the ingredients are combined in a matrix structure. In another embodiment, the ingredients are combined in water to form a liquid sweetener.

### Example

The objective of the study was to (a) determine whether experienced panelists would prefer coffee sweetened with sucralose and a low level of a flavor compound over coffee sweetened with sugar, and (b) to approximate the level of flavor strength at which panelists could no longer identify the flavor compound.

Each panelist (n=10) was presented with 2 cups of freshly prepared coffee sweetened with sucrose (control) or sucralose (of equal sweetness) plus a flavor compound and asked to select the one they preferred over the other (forced choice). Panelists were also asked if they detected a flavor difference, and to spontaneously identify that flavor. The flavor systems are proprietary blends termed “vanilla”, “hazelnut”, “mocha”, “cinnamon”, and “caramel”. The flavor intensity was tested at 5%, 10% and 15% of that used in the commercial version of SPLENDA® Flavors for Coffee.

Results of the test showed that 80% of panelists preferred “cinnamon” at 5%, and “vanilla” at 15% over sucrose, but only 20% or fewer detected the flavor. That is, 80% or less of the panelists could detect the flavor. 70% chose “caramel” at 15% over sucrose, but no panelist could correctly attribute the flavor.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A sweetening composition comprising:
a sweetener; and
one or more flavor compounds, wherein the flavor compound is at a level below that which 50% of users can identify the flavor compound when the sweetener composition is used in a user selected beverage or food.

2. The composition of claim 1, wherein the sweetener is a caloric sweetener, a low calorie sweetener, or mixtures thereof.

3. The composition of claim 1, wherein the sweetener is a caloric sweetener selected from the group consisting of sucrose, glucose, fructose, tagatose, lactose, trehalose, maltodextrin, soluble starch, inulin,honey, high fructose corn syrup, molasses, maple syrup, brown rice syrup, fruit juice sweeteners, barley malt, corn syrup, and mixtures thereof.

4. The composition of claim 1, wherein the sweetener is a low calorie sweetener selected from the group consisting of aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, stevia, luo han guo, sugar alcohols, thaumatin, salts, derivatives, and combinations thereof.

5. The composition of claim 1, wherein the sweetener is a sugar alcohol selected from the group consisting of isomalt, erythritol, hydrogenated isomaltulose, hydrogenated starch hydrolyzates, lactitol, maltitol, mannitol, sorbitol, xylitol, and mixtures thereof

6. The composition of claim 1, wherein the flavor compound is vanilla, hazelnut, cinnamon, bergamot, mint, cocoa, mocha, caramel, karob, citrus, berry, menthol, or mixtures thereof.

7. The composition of claim 1, further comprising a carrier.

8. The composition of claim 7, wherein the carrier is selected from the group consisting of a monosaccharide, a disaccharide, inulin, fructooligosaccharide (FOS) and other fibers, maltodextrins, a sugar alcohol, a digestion resistant maltodextrin, a sugar polymer, and mixtures thereof.

9. The composition of claim 1, wherein the flavor compound is at a level below that which 60% of users can identify the flavor compound when the sweetener composition is used in a user selected beverage or food.

10. The composition of claim 1, wherein the flavor compound is at a level below that which 70% of users can identify the flavor compound when the sweetener composition is used in a user selected beverage or food.

11. The composition of claim 1, wherein the flavor compound is at a level below that which 80% of users can identify the flavor compound when the sweetener composition is used in a user selected beverage or food.

12. The composition of claim 1, wherein the beverage is coffee, tea, juice, flavored water, alcohol, soda, powdered soft drink, and mixtures thereof

13. The composition of claim 1, wherein the sweetener composition has a caloric content of 2 kcal/g SES or less.

14. The composition of claim 1, wherein the sweetener composition is a powder or liquid.

15. A sweetening composition comprising:
a low calorie sweetener;
a carrier; and
one or more flavor compounds,
wherein the sweetener composition has a caloric content of 2 kcal/g SES or less, and the flavor compound is at a level below that which 50% of users can identify the flavor compound when the sweetener composition is used in a user selected beverage or food.

16. The composition of claim 15, wherein the flavor compound is at a level below that which 60% of users can identify the flavor compound when the sweetener composition is used in a user selected beverage or food.

17. The composition of claim 15, wherein the flavor compound is at a level below that which 70% of users can identify the flavor compound when the sweetener composition is used in a user selected beverage or food.

18. The composition of claim 15, wherein the flavor compound is at a level below that which 80% of users can identify the flavor compound when the sweetener composition is used in a user selected beverage or food.

19. The composition of claim 15, wherein the low calorie sweetener is selected from the group consisting of aspartame, acesulfame, alitame, brazzein, cyclamic acid, dihydrochalcones, extract of Dioscorophyllum cumminsii, extract of the fruit of Pentadiplandra brazzeana, glycyrrhizin, hernandulcin, monellin, mogroside, neotame, neohesperidin, saccharin, sucralose, stevia, luo han guo, sugar alcohols, thaumatin, salts, derivatives, and combinations thereof.

20. The composition of claim 15, wherein the low calorie sweetener is a sugar alcohol selected from the group consisting of isomalt, erythritol, hydrogenated isomaltulose, hydrogenated starch hydrolyzates, lactitol, maltitol, mannitol, sorbitol, xylitol, and mixtures thereof.

21. The composition of claim 15, wherein the flavor compound is vanilla, hazelnut, cinnamon, bergamot, mint, cocoa, mocha, caramel, karob, citrus, berry, menthol, or mixtures thereof.

22. The composition of claim 15, wherein the carrier is selected from the group consisting of a monosaccharide, a disaccharide, inulin, fructooligosaccharide (FOS) and other fibers, maltodextrins, a sugar alcohol, a digestion resistant maltodextrin, a sugar polymer, and mixtures thereof.
